(19) United States
(12) Patent Application Publication
(10) Pub. No.: US 2010/0277467 A1
(43) Pub. Date: Nov. 4, 2010

(54) DISPLAY DEVICE, METHOD OF CONTROLLING DISPLAY DEVICE, PROGRAM FOR CONTROLLING DISPLAY DEVICE, AND STORAGE MEDIUM CONTAINING PROGRAM FOR CONTROLLING DISPLAY DEVICE

(76) Inventor: Tohru Kurihara, Hiroshima (JP)

Correspondence Address: BIRCH STEWART KOLASCH & BIRCH, PO BOX 747, FALLS CHURCH, VA, 22040-0747, US

(21) Appl. No.: 12/526,262

(22) PCT Filed: Jan. 21, 2008
(86) PCT No.: PCT/JP2008/050678

§ 371 Date: Aug. 6, 2009

(30) Foreign Application Priority Data
Feb. 19, 2007 (JP) 2007-038587

(51) Int. Cl. G06T 1/00

(52) U.S. Cl. 345/418

(57) ABSTRACT

The setting of the vertical and horizontal axes of the screen displayed on a display region unit (9) of a mobile machine (1) for displaying a screen can be varied. The mobile machine (1) comprises a displayability judging section (32) for comparing the area of the display region unit (9) and the display area of the screen with currently set vertical and horizontal axes and judging whether or not the display area of the screen is within the area of the display region unit (9) and a display driver (13) for outputting, if the display area of the screen is larger than the area of the display region unit (9), information for prompting the user to change the setting of the vertical and horizontal axes of the screen. Therefore, the mobile machine (1) can lower the cost needed for development and enables adequate display of the screen by prompting the user to change the setting of the vertical and horizontal axes so that the setting may be adapted to the display region.

### TECHNICAL FIELD

The present invention relates to display devices capable of altering a vertical and horizontal axis setup for a display area where a screen produced by the execution of an installed program is displayed, and relates also to methods of controlling the display device, programs for controlling the display device, and storage media containing such a program for controlling the display device.

### BACKGROUND ART

Easy access to high speed communications and the development of communications technology have enabled mobile terminals (mobile devices), including mobile phones and PDAs (personal digital assistants), to receive new, large volume data-based services. Thus, users are receiving text, images, and other various digital content on mobile devices more often than before. Another recent change is the advent of digital terrestrial broadcasting where the user can receive and view TV programs (video) transmitted in digital format.

With these increasingly frequent opportunities to receive new services and digital terrestrial TV programs, the user often receives digital content that requires different screen shapes during display. For example, the screen should be a landscape for digital terrestrial TV programs and a portrait to display communications information during a phone call.

Some mobile information terminals have been developed including a mechanism that makes them compatible with different display screen shapes: the display section provides a vertically longer display area by default and can be rotated to provide a horizontally longer display area when necessary. There is also technology to display images/videos from different information sources in different screen shapes by efficiently using the display area of the mobile information terminal incorporating the mechanism. See patent literature 1 for an exemplary disclosure.

More specifically, the mobile information terminal above is able to selectively display from either a first or a second information source depending on the relative positions of a first casing (video display section) and a second casing (control button section). The mobile information terminal can accordingly display an image/video filling up the display area without wasting it.

Furthermore, patent literature 2, among others documents, discloses technology of displaying images so that they fit the vertical and horizontal dimensions of the display area, rather than switching between different display area shapes depending on a change in the relative positions of the video display section and the control button section as with the mobile information terminal of patent literature 1. Patent literature 2 reduces distortion of a displayed image by rotating and scaling up/down the image according to the vertical and horizontal dimensions of the display area.

Functions that are common to multiple applications, such as file management, memory management, input/output management, and the provision of a user interface, are provided by the Windows® Mobile operating system (Microsoft) or like basic software. The basic software is designed to display an image by recognizing the display area as either a portrait or a landscape, that is, according to a vertical and horizontal display screen setup. In other words, the basic software incorporates in it those resources which are available for common use by application programs, no matter whether the display area is portrait or landscape. The application software does not need to be aware of the directions of the horizontal and vertical axes for the displayed image.

In the conventional mobile information terminals above, however, no attention is paid to issues which, when the application program is executed to display the screen, could arise from the difference between the physical size of the display area and the size (vertical and horizontal dimensions) of the image displayed in the area. Details follow immediately.

Current and proceeding generations of mobile information terminals have many application programs installed in them. A typical application program is designed to display a screen only either in a portrait or landscape display area. Few programs are designed to be compatible with both types of display areas.

The mobile information terminals of patent literatures 1 and 2 do not properly determine whether the execution screen of the application program is compatible only with the portrait or only with the landscape.

In addition, the following problem occurs with the Windows® Mobile and similar operating systems which incorporate non-application specific resources to display screens with different aspect ratios: if the vertical and horizontal dimensions of image data retrieved during the execution of an application program differ from those of the display area, the image is not reproduced appropriately on the screen from the image data.

Accordingly, to display a screen properly in both the display areas with different aspect ratios when an application program is executed on the mobile information terminals of patent literatures 1 and 2 and the mobile information terminal on which the Windows® Mobile operating system is installed, the application program needs to be designed in advance so that it is compatible with display areas with different aspect ratios.

If all the application programs running on the mobile information terminals are to be designed so that they can be compatible with display areas with different aspect ratios in this manner, the development cost of the application programs will increase.

Furthermore, in patent literature 1, even if all the application programs running on the terminal are designed so that they can display a screen properly in both the display areas with different vertical and horizontal dimensions, the terminal is yet to be compatible with externally downloaded programs, such as Java® applications.

Application programs are copyrighted by the provider of the application programs. Some copyright holders do not permit scaling up/down and similar re-designing of the screen display due to concerns that the design, layout, etc. of the screen displayed when the application program is executed may be distorted.

In these cases, if the shape of the display screen does not match the shape of the display area, the mobile information terminal of patent literature 2 and the mobile information terminal on which the Windows® Mobile operating system is installed fail to produce a proper display.

Patent Literature 1

International Publication of Japanese Patent Application Publication, Tokukai, No. WO 2003/056787, (Publication Date: Jul. 10, 2003)

Patent Literature 2

Japanese Patent Application Publication, Tokukai, No. 2002-341857 (Publication Date: Nov. 29, 2002)

### SUMMARY OF INVENTION

The present invention, conceived in view of the problems above, has objectives of providing, at relatively low development cost, a display device capable of properly displaying a screen by prompting the user to alter a vertical and horizontal axis setup for a display area and also of providing a method of controlling the display device, a program for controlling the display device, and a storage medium containing the program for controlling the display device.

The display device in accordance with the present invention is, to achieve the objectives, characterized in that it is a display device capable of altering relationship between a vertical axis and a horizontal axis by means of which to specify a position in a display area in which a first screen produced by execution of an installed program is displayed, wherein the first screen should be displayed at that position, the device including: displayability determining means for comparing a display area range indicating a range of the display area and a first screen range indicating a display range of the first screen specified by means of the relationship between the vertical axis and the horizontal axis of the first screen, to determine whether or not the first screen range fits in the display area range; and output means for, upon the displayability determining means determining that the first screen range does not fit in the display area range, outputting a result of the determination.

The method of controlling a display device in accordance with the present invention is, to achieve the objectives, characterized in that it is a method of controlling a display device capable of altering relationship between a vertical axis and a horizontal axis by means of which to specify a position in a display area in which a first screen produced by execution of an installed program is displayed, wherein the first screen should be displayed at that position, the method including the steps of: the first step of comparing a display area range indicating a range of the display area and a first screen range indicating a display range of the first screen specified by means of the vertical axis and the horizontal axis of the first screen, to determine whether or not the first screen range fits in the display area range; and the second step of, if the display range of the first screen is determined in the first step not to fit in the display area range, outputting a result of the determination.

Altering the relationship between the vertical axis and the horizontal axis of the first screen means altering the relative relationship between the vertical and horizontal axes of the first screen in the display area: for example, if the axis direction designated as the vertical axis of the first screen in the display area is designated as the horizontal axis of the screen, the axis direction designated as the horizontal axis of the first screen will become the vertical axis of the screen.

The structure and method include either the displayability determining means or the first step. The structure and method therefore are able to determine whether or not the first screen can be properly displayed with the relationship between the vertical axis and the horizontal axis specified in the display area, that is, whether or not the first screen range fits in the display area range. In addition, the structure and method include either the output means or the second step and therefore are able to output a result of the determination.

Since the result of the determination is output in this manner, the user of the display device can know that the display range of the first screen does not fit in the display area range with the specified relationship between the vertical axis and the horizontal axis. If the first screen cannot be displayed in the display area with the specified relationship between the vertical axis and the horizontal axis, the relationship between the vertical axis and the horizontal axis can be altered so that the first screen can be displayed properly.

In addition, if the first screen cannot be displayed in the display area with the specified relationship between the vertical axis and the horizontal axis, the user is prompted to alter the relationship between the vertical axis and the horizontal axis. The first screen can therefore be displayed properly in the display area without resizing, trimming, or any other particular processing even if the copyright holder who provides the application program does not want the design, layout, etc. of the first screen produced by the execution of the application program to be degraded and hence disapproves scaling up/down (resizing) of the first screen or trimming where part of an image is cut off for display.

Furthermore, no program for displaying the first screen that is compatible with the vertical and horizontal axes that can be set up in the display area needs to be designed in advance, which lowers development cost.

The display device and the method of controlling a display device in accordance with the present invention have advantages that development cost is lowered and that the screen is properly displayed by prompting the user to alter the vertical and horizontal axis setup corresponding to the display area.

### BRIEF DESCRIPTION OF DRAWINGS

FIG. 1, illustrating an embodiment of the present invention, is a block diagram of a software configuration for a mobile device in relation to application execution properness determining processes.

FIG. 2 is a drawing showing, as an example, a relative rotation of a display section with respect to a main body section of a mobile device in accordance with the present embodiment.

FIG. 3, illustrating an embodiment of the present invention, is a block diagram of major parts of the mobile device.

FIG. 4 is a drawing showing an exemplary prompt displayed on a mobile device in accordance with the present embodiment.

FIG. 5 is a drawing showing another exemplary prompt displayed on a mobile device in accordance with the present embodiment.

FIG. 6, illustrating an embodiment of the present invention, is a flow chart showing the flow of an execution properness determining process 1 carried out by an application program on the mobile device.

FIG. 7, illustrating an embodiment of the present invention, is a flow chart showing the flow of an execution properness determining process 2 carried out by an application program on the mobile device.

FIG. 8, illustrating an embodiment of the present invention, is a block diagram of a software configuration for a mobile device in relation to a display-data display properness determining process.

FIG. 9 is a drawing showing exemplary display range information stored in a mobile device in accordance with the present embodiment.

FIG. 10(a) is a drawing illustrating the vertical and horizontal dimensions of a display area section of a mobile device in accordance with the present embodiment and those dimensions of a screen displayed on the display area section.

FIG. 10(b) is a drawing illustrating the vertical and horizontal dimensions of a display area section of a mobile device in accordance with the present embodiment and those dimensions of a screen displayed on the display area section.

FIG. 11 is a flow chart depicting a display-data display properness determining process 1 carried out by a mobile device in accordance with the present invention.

FIG. 12 is a drawing showing an exemplary display produced based on prompt data by a mobile device in accordance with the present invention.

FIG. 13 is a flow chart depicting a display-data display properness determining process 2 carried out by a mobile device in accordance with the present invention.

### DESCRIPTION OF EMBODIMENTS

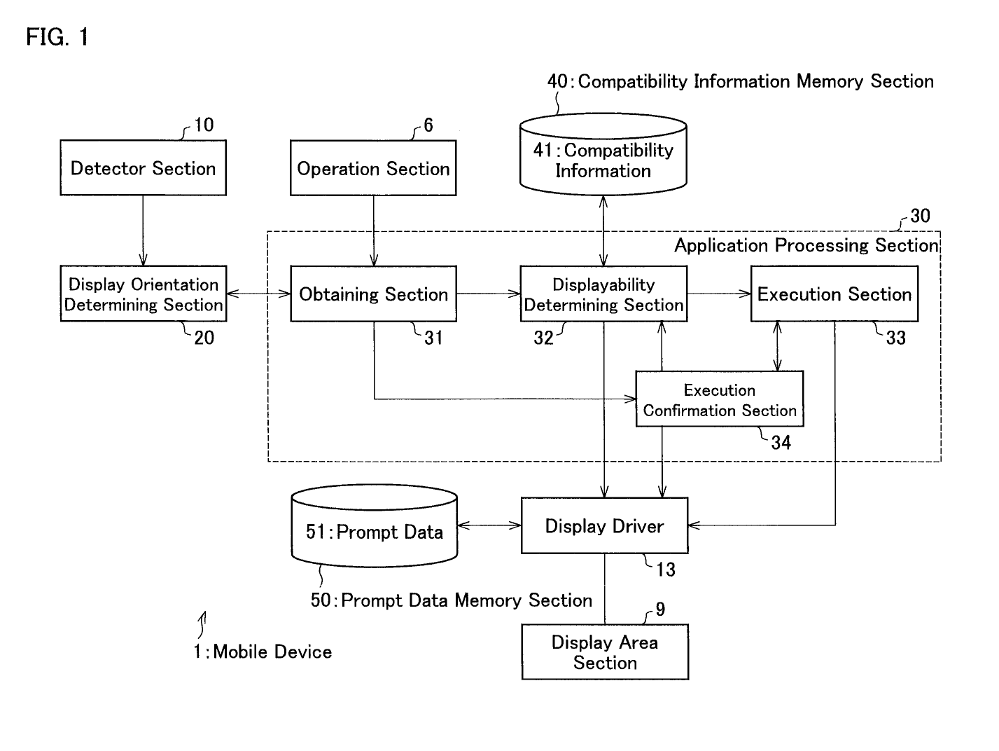

The following will describe an embodiment of the present invention in reference to FIGS. 1 to 13. A mobile device 1 in accordance with the present embodiment is a communications terminal that can be carried around for use by a user, such as a mobile phone or a PDA.

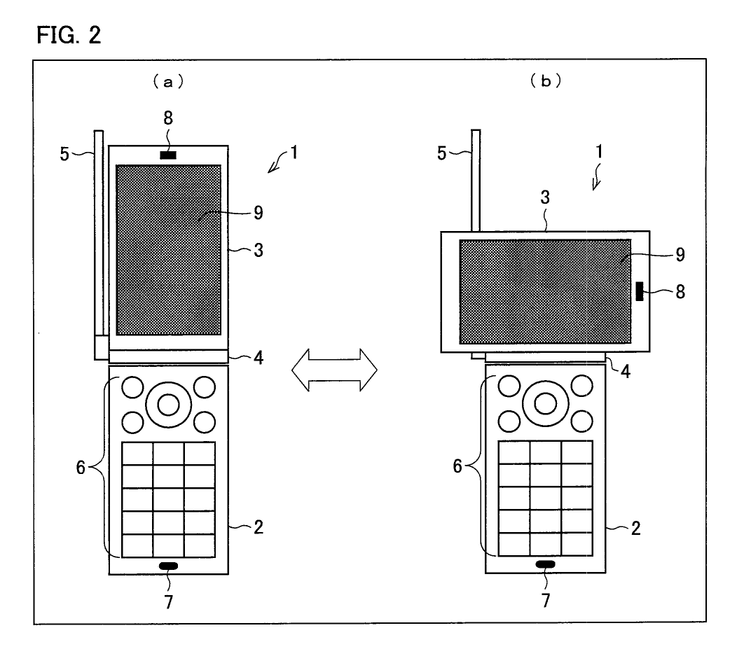

Referring to (a) of FIG. 2 and (b) of FIG. 2, the mobile device 1 is composed primarily of a main body section 2, a display section 3, a hinge section 4, and a TV antenna 5. The main body section 2 is provided on its front with an operation section 6 and a microphone 7 and inside it with a communications antenna 17 (not shown in (a) of FIG. 2 and (b) of FIG. 2). The display section 3 is provided on its front with a speaker 8 and a display area section 9. The hinge section 4 connects the main body section 2 and the display section 3. The TV antenna 5 receives digital terrestrial broadcasts. (a) and (b) of FIG. 2 are drawings showing, as an example, a relative rotation of the display section 3 with respect to the main body section 2 of the mobile device 1 in accordance with the present embodiment.

The mobile device 1 outputs sound from the speaker 8 and receives sound input at the microphone 7, for example, during a phone call with another communications device. The mobile device 1 receives various control command inputs and other manipulation through the operation section 6. The mobile device 1 is also adapted to display, on the display area section 9, various information (images, text, etc.) and video data contained in broadcast signals received through the TV antenna 5.

The operation section 6 may include, for example, numeric keys, menu keys or like operation buttons, and a cross key. The display area section 9 is disposed in front of the display section 3 and rectangular with different vertical and horizontal dimensions. The display area section 9 may be built, for example, around an LCD (liquid crystal display).

As shown in (a) of FIG. 2, the mobile device 1 in accordance with the present embodiment includes a rotation mechanism, connecting the display section 3 to the main body section 2, which enables clockwise rotation of the display section 3 relative to the main body section 2 from the position where the long sides of the main body section 2 and the display section 3 are aligned to the position where the long sides cross at right angles as in (b) of FIG. 2. The rotation mechanism, located in the hinge section 4, enables switching of the shape of the display area section 9 in the display section 3 between portrait and landscape. Throughout the description below, the portrait refers to the shape of the display area section 9 in which the vertical side of the display section 3 is longer than the horizontal side with respect to the main body section 2 in (a) of FIG. 2, and the landscape refers to the shape of the display area section 9 in which the vertical side of the display section 3 is shorter than the horizontal side.

The mobile device 1 in accordance with the present embodiment is adapted to, upon changing the shape of the display area section 9 as above, also change the vertical and horizontal axis setup for the screen (first screen) displayed on the display area section 9. For example, when the display section 3 is rotated clockwise relative to the main body section 2 from the position where the long sides of the main body section 2 and the display section 3 are aligned to the position where the long sides cross at right angles, the setup is altered so that the direction of the new horizontal axis matches that of the original vertical axis and the direction of the new vertical axis matches that of the original horizontal axis in the display area.

In other words, in the mobile device 1 in accordance with the present embodiment, the vertical and horizontal axis setup for the screen produced on the display area section 9 by the execution of an application program is altered in conjunction with the change of the relative position of the display section 3 with respect to the main body section 2.

The screen produced on the display area section 9 by the execution of an application program corresponds to the first screen of the present invention as mentioned above. The screen produced from display data 71 (detailed later) in the screen produced by the execution of the application program corresponds to a second screen of the present invention.

The mobile device 1 further includes a detector section 10 (not shown in FIG. 2) in the connection of the hinge section 4 and the display section 3. The detector section 10 detects the direction and time of the rotation achieved by the rotation mechanism and collects information about the relative current position of the display section 3 with respect to the main body section 2. The detector section 10 outputs the information about the direction and time of the rotation achieved by the rotation mechanism (rotation information) to a main control section 16 and/or in response to a request from the main control section 16, outputs the information about the relative position of the display section 3 with respect to the main body section 2 (display section position information) to the main control section 16.

The rotation information includes the timing information of the rotation of the display section 3 by the rotation mechanism and the post-rotational display section position information. The display section position information indicates whether the display area section 9 on the display section 3 is a landscape or a portrait.

The detector section 10 outputs the rotation information to the main control section 16 and/or in response to a request from the main control section 16, collects and outputs the display section position information to the main control section 16. From the results of the detection by the detector section 10, the mobile device 1 can know whether the current shape of the display area section 9 is portrait or landscape.

### Hardware Configuration of Mobile Device

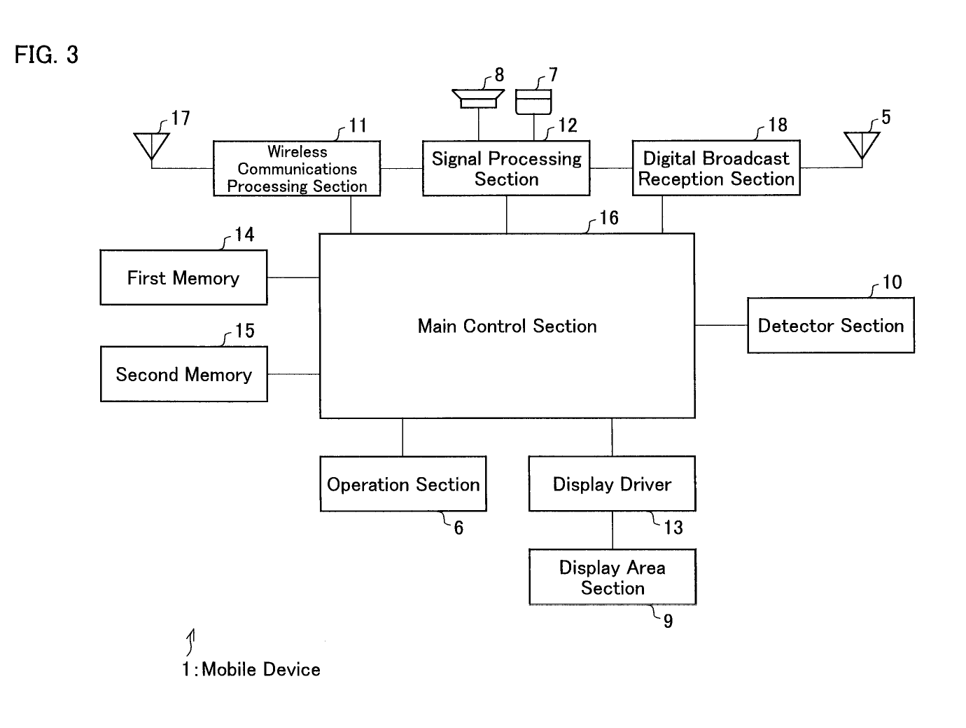

Next, the hardware configuration of the mobile device 1 incorporating the rotation mechanism will be detailed in reference to FIG. 3. FIG. 3, illustrating an embodiment of the present invention, is a block diagram of major parts of the mobile device 1.

The mobile device 1 in accordance with the present embodiment, as illustrated in FIG. 3, contains a wireless communications processing section 11, a signal processing section 12, a display driver 13, a first memory 14, a second memory 15, the main control section 16, and a digital broadcast reception section 18, as well as the hinge section 4, the TV antenna 5, the operation section 6, the microphone 7, the speaker 8, the display area section 9, the detector section 10, and the communications antenna 17.

The first memory 14 acts like a buffer. The second memory 15 provides a permanent data storage like flash memory. The first memory 14 and the second memory 15, which are memory devices for the mobile device 1, may be adapted to the specifications of the mobile device 1. For example, the memories 14 and 15 may be integrated into a single device.

The second memory 15 stores a system program which provides file management, memory management, input/output management, user interface, and other related functions on the mobile device 1 and also stores application programs which run under the system program.

The main control section 16 controls various components of the mobile device 1 and may be, for example, a CPU. If the main control section 16 is built around a CPU as an example, the components of the mobile device 1 can be controlled by the CPU loading the system program (OS) from the second memory 15 where the program is stored to the first memory 14 and executing the program there.

The mobile device 1, configured as above, performs a phone call, television reception, execution of applications, and like operations as detailed below.

First, the mobile device 1 transmits signals to and receives signals from a base station (not shown) via the communications antenna 17 under the transmission/reception control of the wireless communications processing section 11, and carries out predetermined signal processing on the incoming and outgoing signals in the signal processing section 12. The mobile device 1 hence provides a phone call function whereby the sound transmitted from another device via the base station is output from the speaker 8 and the sound input at the microphone 7 is transmitted to the other device via the base station.

The mobile device 1 receives OFDM-modulated broadcast signals at the TV antenna 5, demodulates the broadcast signals in the digital broadcast reception section 18, and carries out predetermined signal processing on the demodulated broadcast signals in the signal processing section 12. From the received broadcast signals, the device 1 outputs video on the display area section 9 under the control of the display driver 13 and sound from the speaker 8. The device 1 hence provides a television reception function. The digital broadcast reception section 18 may be built around a tuner which makes channel settings for a desirable TV program and a demodulator which demodulates TV program broadcast data received according to the settings.

The mobile device 1 is also capable of providing an application execution function by which the main control section 16 retrieves application programs from the second memory 15 for execution according to user command inputs on the operation section 6.

The mobile device 1 may provide any functions other than the phone call, television reception, and application execution functions. For example, the device may further contain an image capturing section (not shown) with which an photo-taking camera function may be provided. The image capturing section may made from a CCD (charge coupled device) or a CMOS.

As explained earlier, the mobile device 1 in accordance with the present embodiment has a rotation mechanism enabling the display section 3 to rotate with respect to the main body section 2 by 90°. The vertical and horizontal axis setup for the screen displayed on the display area section 9 is altered in response to the rotation (movement) of the display section 3.

The display area section 9 of the display section 3 can hence switch between the portrait and the landscape. At the same time, the ratio of the vertical and horizontal dimensions of the screen displayed on the display area section 9 is altered.

If the screen displayed by the execution of the application program is designed for a portrait display area, whereas the display area section 9 is landscape, the screen displayed by the execution of the application program does not match the display area section 9.

The mobile device 1 in accordance with the present embodiment is adapted to determine if the application program can be executed properly with the current position of the display section 3 and display a prompt if the program cannot be properly executed. This process of determining whether or not the application program can be executed properly with the current position of the display section 3 and displaying a prompt if the program cannot be properly executed will be called the application execution properness determining process throughout the rest of the document.

The application execution properness determining processes performed on the mobile device 1 in accordance with the present embodiment will be described in detail below.

### Application Execution Properness Determining Processes 1 and 2

In reference to FIGS. 1, 4, and 5, the following will describe an execution properness determining process performed when the application program is started under the system program (application execution properness determining process 1) and an application execution properness determining process performed when the display section 3 is moved (or rotated) (application execution properness determining process 2).

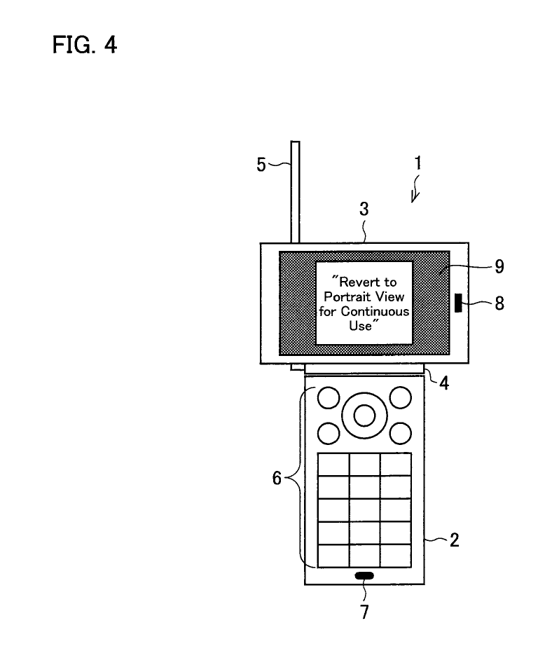

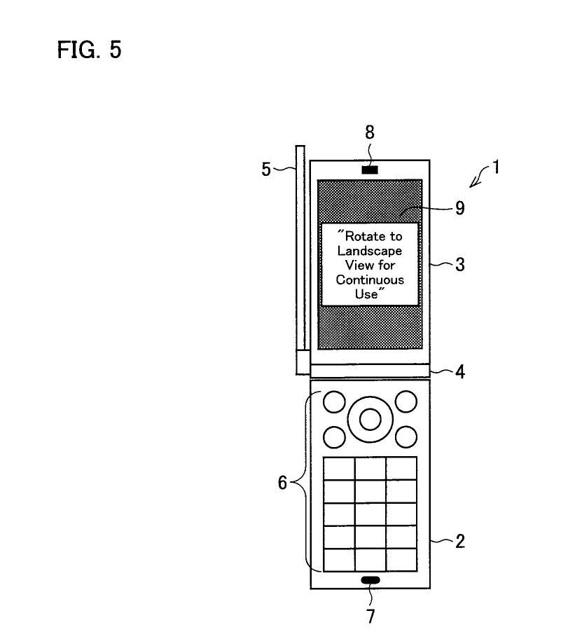

Suppose that the application program executed is pre-installed in the mobile device 1 in accordance with the present embodiment. FIG. 1, illustrating an embodiment of the present invention, is a block diagram of a software configuration for the mobile device 1 in relation to the application execution properness determining processes 1 and 2. FIGS. 4 and 5 are drawings each showing an exemplary prompt displayed on the mobile device 1 in accordance with the present embodiment.

### Software Configuration for Mobile Device Relating to Application Execution Properness Determining Processes 1 and 2

As illustrated in FIG. 1, the mobile device 1 in accordance with the present embodiment includes a display orientation determining section 20 and an application processing section 30 as functional blocks in the software configuration in relation to the application execution properness determining processes 1 and 2. The device 1 also includes, as the storage media realized as the second memory, a compatibility information memory section 40 where compatibility information 41 is stored and a prompt data memory section 50 where prompt data 51 is stored.

The compatibility information 41 indicates the shape, of the display area section 9, which can be handled by the application program. In other words, the compatibility information 41 indicates if the screen displayed after the execution of the application program is compatible with the display area section 9 in the portrait mode, the landscape mode, or both modes.

The prompt data 51 is text data that notifies the user when the application program executed is not fully compatible with the current position of the display section 3, prompting him/her to rotate the display section 3 by 90°.

The display orientation determining section 20 determines the current relative position of the display section 3 with respect to the main body section 2 based on the rotation information fed from the detector section 10 or the display section position information obtained from the detector section 10 in response to an instruction from the application processing section 30. In other words, the display orientation determining section 20 determines whether the display area section 9 is portrait or landscape. The display orientation determining section 20 outputs results to the application processing section 30. The display orientation determining section 20 is a functional block which, for example, if the main control section 16 is a CPU, may be implemented by the CPU loading the system program from the second memory 15 where the program is stored to the first memory and executing the program there.

The application processing section 30 determines, based on results of the determination by the display orientation determining section 20, whether or not the dimensions on the vertical and horizontal axes set up on the screen displayed by the execution of the application program are compatible with the current position of the display section 3, that is, the shape of the display area section 9, for the execution the application program.

The application processing section 30 includes an obtaining section 31, a displayability determining section 32, an execution section 33, and an execution confirmation section 34 as functional blocks. The application processing section 30 is a functional block which, for example, if the main control section 16 is a CPU, may be implemented by the CPU loading the application program from the second memory 15 where the program is stored to the first memory and starting the program there.

The obtaining section 31 obtains the results of the determination as to the relative position of the display section 3 with respect to the main body section 2 from the display orientation determining section 20 in response to the input of an execution command for the application program through the operation section 6. The obtaining section 31 also receives the results of the determination made by the display orientation determining section 20 on the rotation information fed from the detector section 10.

Upon obtaining the results of the determination as to the relative position of the display section 3 with respect to the main body section 2 from the display orientation determining section 20, the obtaining section 31 outputs the results of the determination to the displayability determining section 32. Meanwhile, upon receiving the results of the determination made by the display orientation determining section 20 on the rotation information fed from the detector section 10, the obtaining section 31 outputs the results of the determination to the execution confirmation section 34.

The displayability determining section 32 determines whether or not the display range of the screen displayed by the execution of the application program is within the range of the current display area section 9 by referring to the compatibility information 41 stored in the compatibility information memory section 40 and based on the results of the determination made by the display orientation determining section 20 and fed from the obtaining section 31.

The displayability determining section 32 is hence capable of knowing the current shape (range) of the display area section 9 from the information fed from the obtaining section 31. Meanwhile, the displayability determining section is capable of determining, from the compatibility information 41, whether the application program started is designed to be compatible with a portrait display area section 9 or a landscape display area section 9. In other words, the section 32 can determine whether the display range of the screen displayed by the execution of the application program fits the portrait display area section 9 or the landscape display area section 9.

In this manner, the displayability determining section 32 determines if the range of the screen displayed by the execution of the application program is compatible with the shape of the display area section 9 on the display section 3 located at the current position. In other words, the displayability determining section 32 is capable of determining whether or not the application program executed is compatible with the current display area section 9.

If the application program executed is determined to be compatible with the current display area section 9, the displayability determining section 32 instructs the execution section 33 to execute the application program. In response to this instruction, the execution section 33 continues the execution of the application program.

On the other hand, if the application program executed is determined to be incompatible with the current display area section 9, the section 32 instructs the execution section 33 to stop the execution of the application program. In response to this instruction, the execution section 33 temporarily suspends the execution of the application program.

Furthermore, if the application program executed is determined to be incompatible with the current display area section 9, the displayability determining section 32 instructs the display driver 13 to display the prompt data 51. The display driver 13, in response to the instruction, controls so that the prompt data 51 can be retrieved from the prompt data memory section 50 and displayed on the display area section 9. The prompt data 51 displayed on the display area section 9 may have the following content, as an example.

If the display section 3 is located at a position where the display area section 9 is landscape, and the displayability determining section 32 determines that the application program executed is incompatible with the shape of the display area section 9, a prompt is displayed as illustrated in FIG. 4, saying: “Revert to Portrait View for Continuous Use.” “Revert to Portrait View” here indicates the movement (rotation) of the display section 3 to a position where the display area section 9 is portrait.

On the other hand, if the display section 3 is located at a position where the display area section 9 is portrait, and the displayability determining section 32 determines that the application program executed is incompatible with the shape of the display area section 9, a prompt is displayed as illustrated in FIG. 5, saying: “Rotate to Landscape View for Continuous Use.” “Rotate to Landscape View” here indicates the movement (rotation) of the display section 3 to a position where the display area section 9 is landscape.

The execution section 33 executes or stops the application program. The execution section 33 responds to an enquiry from the execution confirmation section 34 (detailed below) as to the execution status of the application program.

The execution confirmation section 34, upon receiving from the obtaining section 31 the results of the determination made by the display orientation determining section 20 on the rotation information, makes an enquiry to the execution section 33 to confirm the execution status of the application program on the mobile device 1.

For example, if the execution confirmation section 34 confirms, upon receiving the results of the determination made by the display orientation determining section 20 on the rotation information, that a display is produced based on the prompt data 51 and also that the execution of the application program is temporarily being suspended, the section 34 instructs the display driver 13 to discontinue the display produced based on the prompt data 51. The section 34 then instructs the execution section 33 to resume the execution of the temporarily suspended application program.

In addition, for example, if the execution confirmation section 34 determines, upon receiving the results of the determination made by the display orientation determining section 20 on the rotation information, that the execution confirmation section 34 is executing the application program, the section 34 instructs the displayability determining section 32 to determine whether or not the application program being executed is compatible with the current position of the display section 3 after the above movement.

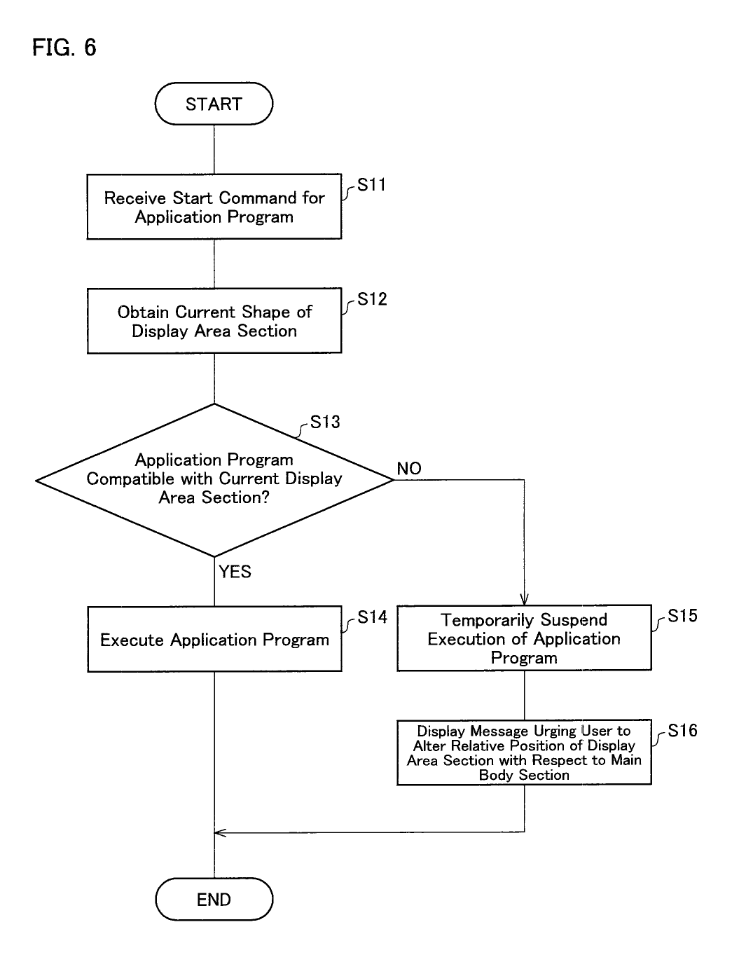

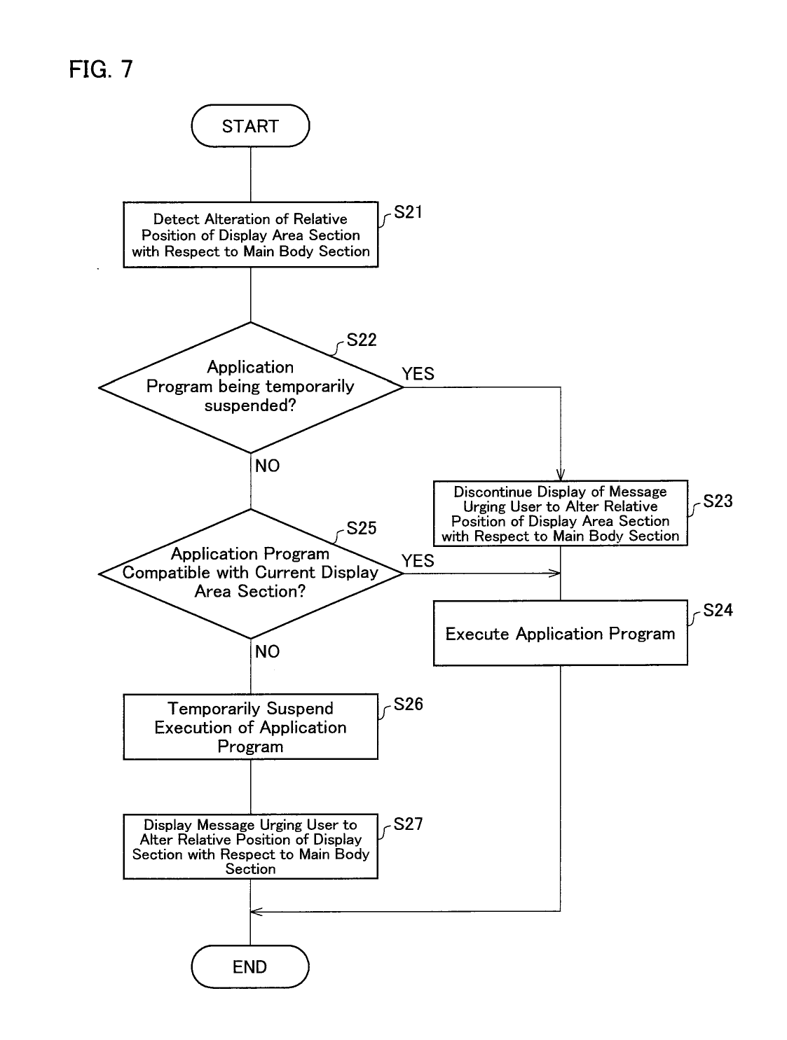

The following will describe the flow of the execution properness determining process 1 for the application program in reference to FIG. 6 and the flow of the execution properness determining process 2 for the application program in reference to FIG. 7. Both flows are executed on the mobile device 1 configured as above. FIG. 6, illustrating an embodiment of the present invention, is a flow chart showing the flow of the execution properness determining process 1 for the application program carried out by the mobile device 1. FIG. 7, illustrating an embodiment of the present invention, is a flow chart showing the flow of the execution properness determining process 2 for the application program carried out by the mobile device 1.

### Flow of Execution Properness Determining Process 1 for Application Program

First, the operation section 6 receives a start command for the application program from the user (step S11; hereinafter “S11”). Upon receiving the start command, the operation section 6 notifies the obtaining section 31 of the command. The obtaining section 31, in response to the start command from the operation section 6, instructs the display orientation determining section 20 to determine whether the current display area section 9 is portrait or landscape.

According to the instruction, the display orientation determining section 20 obtains display position information from the detector section 10, determines the current shape of the display area section 9, and outputs results of the determination to the obtaining section 31.

The obtaining section 31 obtains the information on the shape of the display area section 9 as to whether the display area section 9 is portrait or landscape in this manner (S12) for output to the displayability determining section 32.

The displayability determining section 32 determines whether or not the application program for which the start command was entered is compatible with the current shape of the display area section 9, by referring to the information on the shape of the display area section 9 and the compatibility information 41 stored in the compatibility information memory section 40 (S13).

If the answer is “YES” in step S13, the displayability determining section 32 makes the execution section 33 to execute the application program (S14). On the other hand, if the answer is “NO” in step S13, the displayability determining section 32 has the execution of the application program temporarily suspended (S15) and controls the display driver 13 to have the display area section 9 display the prompt data 51.

According to instructions from the displayability determining section 32, the display driver 13 retrieves the prompt data 51 from the prompt data memory section 50 and displays a prompt urging the user to alter the relative position of the display area section 9 with respect to the main body section 2 (S16).

The mobile device 1 in accordance with the present embodiment is capable of executing the execution properness determining process 1 for the application program as described in the foregoing.

The data (prompt data 51) for the message displayed on the display area section 9 to prompt the user for alteration is designed so that the prompt can be displayed properly no matter whether the display area section 9 is portrait or landscape.

### Flow of Execution Properness Determining Process 2 for Application Program

Next, the flow of the execution properness determining process 2 for the application program when the relative positions of the display section 3 and the main body section 2 are altered, that is, when the rectangle shape of the display area section 9 is altered, will be described in reference to FIG. 7.

The user alters the relative positions of the display section 3 and the main body section 2. In other words, the vertical and horizontal axis setup for the screen on the display area section 9 is altered. The detector section 10 detects the alteration (S21) and outputs, to the obtaining section 31, results of the detection, that is, the rotation information, to the display orientation determining section 20. The display orientation determining section 20 outputs the alteration of the relative position of the display section 3 with respect to the main body section 2 and the results of the determination as to the post-alteration shape of the display area section 9. In other words, the display orientation determining section 20 outputs results of the determination on the received rotation information to the obtaining section 31.

Upon receiving the results of the determination on the rotation information from the display orientation determining section 20, the obtaining section 31 outputs the results to the execution confirmation section 34. The execution confirmation section 34, upon receiving the rotation information, sends an enquiry to the execution section 33 to confirm the execution status of the application program. The section 34 then confirms whether or not the application program is being temporarily suspended (S22).

An alteration of the relative positions of the display section 3 and the main body section 2 is made either in response to the message displayed in step S16 in the flow of the execution properness determining process 1 for the application program or regardless of the message. It is determined in step S22 in which one of the two cases the alteration falls.

A “YES” in step S22 corresponds to the case where the display section 3 was moved in response to the message displayed in step S16 in the flow of the execution properness determining process 1 for the application program. Therefore, the “YES” in step S22 indicates that the display section 3 was moved to the position with which the application program executed is compatible.

Accordingly, if the answer is “YES” in step S22, the execution confirmation section 34 instructs the display driver 13 to discontinue the display of the message (prompt data 51) prompting the user to alter the relative position of the display section 3 with respect to the main body section 2. In response to the instruction, the display driver 13 discontinues the display of the message (S23).

The execution confirmation section 34 then instructs the execution section 33 to resume the temporarily suspended execution of the application program. Upon receiving the instruction from the execution confirmation section 34, the execution section 33 executes the application program (S24).

If the answer is “NO” in step S22, that part of the process which follows (steps S25 to S27 and S24) is the same as steps S13 to S16 in the aforementioned flow of the execution properness determining process 1 for the application program. Detailed description of that part is omitted.

In step S25, the displayability determining section 32 determines, based on the results of the determination made by the display orientation determining section 20 and fed from the execution confirmation section 34 and based also on the compatibility information 41 retrieved from the compatibility information memory section 40, whether the application program executed is compatible with the current display area section 9 (S25). If the program executed is determined to be compatible with the section 9 (“YES” in step S25), the displayability determining section 32 instructs the execution section 33 to continue the execution of the application program (S24).

On the other hand, if the answer is “NO” in step S25, the displayability determining section 32 instructs the execution section 33 to temporarily suspend the execution of the application program (S26). Furthermore, the section 32 instructs the display driver 13 to display a message on the display area section 9 prompting the user to alter the relative position of the display section 3 with respect to the main body section 2 (S27).

The mobile device 1 executes the execution properness determining process 2 for the application program as described in the foregoing when the relative position of the display section 3 with respect to the main body section 2 is altered.

The mobile device 1 in accordance with the present embodiment is hence capable of, when the application program is executed and when the display section 3 is moved, determining whether the display screen for the application program executed is compatible with the shape of the display area section 9.

If the display screen is not compatible with the shape, the mobile device 1 can prompt the user to move the display section 3 so that the display screen for the application program executed is compatible with the shape of the display area section 9, in other words, the vertical and horizontal axis setup for the display screen on the display area section 9 is compatible with the vertical and horizontal axes of the screen that the application program is able to display.

The capability to prompt the user to move the display section 3, that is, to alter the vertical and horizontal axis setup for the screen displayed on the display area section 9 enables alteration of the vertical and horizontal axis setup for proper display of the first screen even if the screen produced by the execution of the application program does not fit into the display area section 9 under the current vertical and horizontal axis setup for the display screen on the display area section 9.

The capability is particular beneficial when, as an example, the copyright holder of the application program does not want the design, layout, etc. of the screen displayed by the execution of the application program to be degraded and hence disapproves scaling up/down and similar manipulation of the screen, because the capability enables a proper display without the scaling up/down or similar manipulation.

Another benefit of the mobile device 1 in accordance with the present embodiment is reduced cost of application program development because the device 1 does not require that the application program executed be designed in advance with such a display capability as to be compatible with display areas having different aspect ratios.

Furthermore, the device 1 is adapted to know the current shape of the display area section 9, confirm the shape of the display area section 9 with which the application program executed is compatible, and instruct to move the display section 3 where necessary. Therefore, the mobile device 1 in accordance with the present embodiment only needs to have information on the compatible shape of the display area section 9 so as to be applicable to externally downloaded application programs, such as Java® applications.

In the foregoing description, it has been determined if the application program pre-installed in the mobile device 1 in accordance with the present embodiment is compatible with the current shape of the display area section 9, that is, the current position of the display section 3.

Another possible arrangement is to obtain display data and execute the application program by utilizing the display data, in other words, to display a screen based on the display data on a screen produced by the execution of the application program.

Accordingly, the following will describe a “display-data display properness determining process” whereby it is determined if the screen produced from the display data in this manner can be displayed on the screen produced by the execution of the application program with the current position of the display section 3.

The “display-data display properness determining process” carried out when the application program is executed utilizing display data selected is termed the “display-data display properness determining process 1.” Meanwhile, the “display-data display properness determining process” carried out when a rotational movement of the display section 3 is detected while the application program utilizing display data is being executed is termed the “display-data display properness determining process 2.”

### Software Configuration Related to Display-Data Display Properness Determining Processes 1 and 2

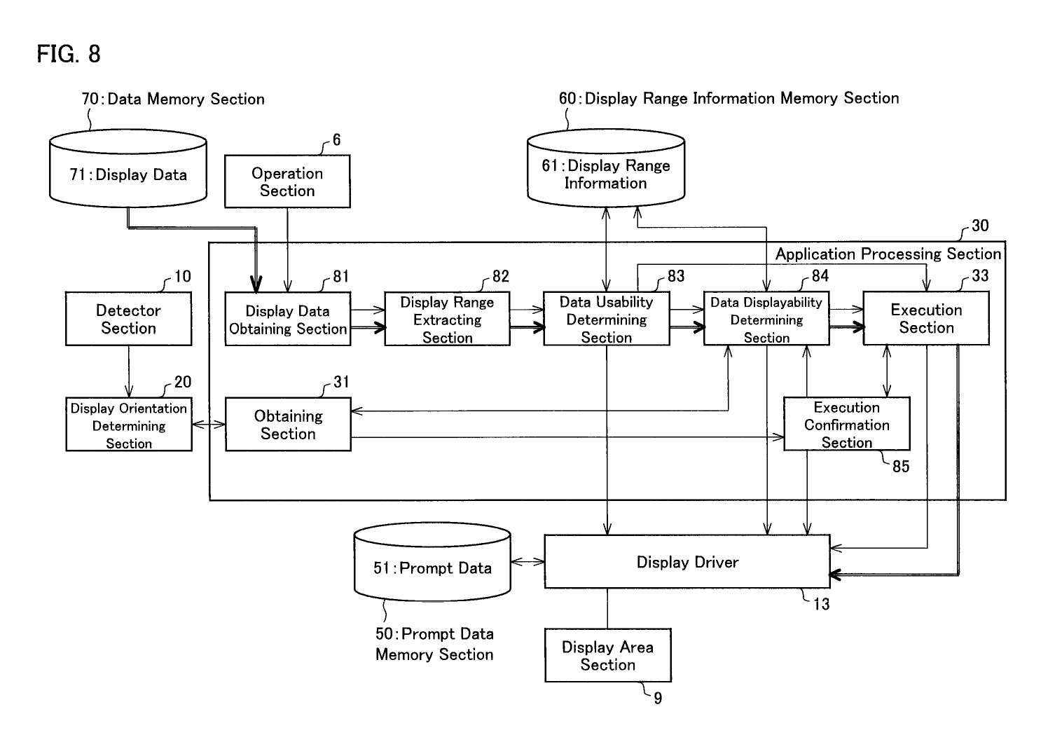

First, a software configuration for the mobile device 1 will be described in relation to the “display-data display properness determining processes 1 and 2” in reference to FIG. 8. FIG. 8, illustrating an embodiment of the present invention, is a block diagram of a software configuration for the mobile device 1 in relation to the “display-data display properness determining processes 1 and 2.”

First, before describing the software configuration for the mobile device 1 in relation to the “display-data display properness determining processes 1 and 2,” information utilized in the configuration and a memory device which stores the information will be described.

The mobile device 1 in relation to the “display-data display properness determining processes 1 and 2” further includes a display range information memory section 60 and a data memory section 70 both of which can be realized as the second memory 15. The display range information memory section 60 stores display range information 61, and the data memory section 70 stores display data 71.

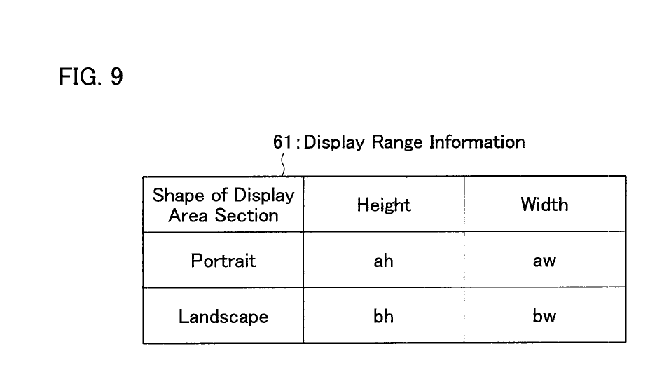

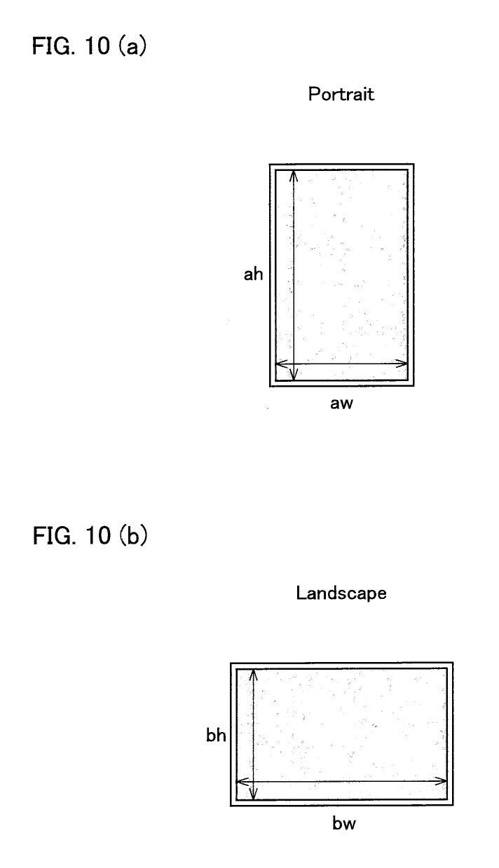

The display range information 61 is information on the range of a screen displayed by the execution of the application program. More specifically, the information 61 is information on the dimensions of the vertical and horizontal axes displayable on the screen produced by the execution of the application program in the two cases given in FIG. 9: when the shape of the display area section 9 is portrait (i.e., the vertical axis of the screen is longer than the horizontal axis) and when it is landscape (i.e., the vertical axis of the screen is shorter than the horizontal axis). The vertical and horizontal dimensions are preset in the application program for both cases as illustrated in FIGS. 10(a) and 10(b) (i.e., the case where the shape of the display area section 9 is portrait and the case where it is landscape).

FIG. 9 is a drawing showing, as an example, the display range information 61 stored in the mobile device 1 in accordance with the present embodiment. FIGS. 10(a) and 10(b) are drawings illustrating the vertical and horizontal dimensions of the display area section 9 of the mobile device in accordance with the present embodiment and those dimensions of a screen displayed in the display area section 9.

The display data 71 is image data retrieved upon the execution of the application program. Upon the execution of the application program, a screen produced from the display data 71 is displayed on the screen produced by the execution of the application program.

The mobile device 1 in accordance with the present embodiment is adapted to store in advance the display data 71 that is used when the application program is executed. This is however not intended to be limiting the invention.

Alternatively, the device 1 may be adapted to externally obtain the display data 71 using the communications antenna 17, the wireless communications processing section 11, and the signal processing section 12 when the application program is executed.

The application processing section 30 in the software configuration for the mobile device 1 in relation to the “display-data display properness determining processes 1 and 2” includes, as functional blocks, a display data obtaining section 81, a display range extracting section 82, a data usability determining section 83, a data displayability determining section 84, and an execution confirmation section 85, as well as an obtaining section 31 and an execution section 33. The obtaining section 31 and the execution section 33 here are the same as the obtaining section 31 and the execution section 33 shown in FIG. 1; the same reference numerals are given and their description is omitted. The execution confirmation section 85 differs from the execution confirmation section 34 shown in FIG. 1 only in the following point. The sections 85 and 34 fundamentally have the same functions.

The execution confirmation section 34 in the application processing section 30 shown in FIG. 1 enquires about the execution status of the application program. This is different from the execution confirmation section 85 in the application processing section 30 shown in FIG. 8 in that the section enquires, as the execution status of the application program, whether or not the application program is producing a display from the display data 71.

The display data obtaining section 81 retrieves and obtains the display data 71 from the data memory section 70 in response to a request from the operation section 6 to obtain the display data 71. The display data obtaining section 81 outputs the obtained display data 71 to the display range extracting section 82.

The display range extracting section 82 analyzes the display data 71 fed from the display data obtaining section 81 to extract display-data display range information out of the display data 71. The display-data display range information specifies a range where the display data 71 can be displayed properly. The display range extracting section 82 outputs the extracted display-data display range information together with the received display data 71 to the data usability determining section 83.

The data usability determining section 83 determines whether the display data 71 obtained fits in the range the display screen of the application program after execution. More specifically, the data usability determining section 83 determines whether or not the screen produced from the display data 71 fits in the range of the display screen of the application program, based on the display-data display range information extracted by the display range extracting section 82 and the display range information 61 obtained from the display range information memory section 60.

If the screen produced from the display data 71 is determined not to fit in the range of the display screen of the application program, the data usability determining section 83 instructs the execution section 33 to stop the display of the display data 71. The data usability determining section 83 further instructs the display driver 13 to display on the display area section 9 information indicating that the data cannot be displayed.

On the other hand, if the screen produced from the display data 71 is determined to fit in the range of the display screen of the application program, the data usability determining section 83 outputs the display-data display range information together with the display data 71 to the data displayability determining section 84. The section 83 then instructs the data displayability determining section 84 to determine whether or not the screen produced from the display data 71 can be displayed properly in the current shape of the display area section 9. In other words, the section 83 instructs the data displayability determining section 84 to determine whether or not the screen produced from the display data 71 can be displayed properly on the screen produced by the execution of the application program in the range specified by means of the vertical and horizontal axes of the screen set up on the current display area section 9.

The data displayability determining section 84 determines whether the display data 71 can be displayed in the current shape of the display area section 9. In other words, the data displayability determining section 84 determines whether the screen produced from the display data 71 can be displayed properly on the screen produced by the execution of the application program in the range specified by means of the vertical and horizontal axes of the screen set up on the current display area section 9.

The data displayability determining section 84 instructs the obtaining section 31 to obtain information on the current relative position of the display section 3 with respect to the main body section 2 (display section position information).

The data displayability determining section 84 then learns the current relative position of the display section 3 with respect to the main body section 2, that is, the shape of the display area section 9, from the information obtained from the obtaining section 31. In other words, the data displayability determining section 84 learns the dimensions of the vertical and horizontal axes of the screen set up on the current display area section 9 from the information obtained from the obtaining section 31.

The section 84 also determines whether the screen produced from the display data 71 fits in the display range of the screen produced by the application program in the current shape of the display area section 9, based on the display-data display range information received from the data usability determining section 83 and the display range information 61 obtained from the display range information memory section 60.

If the screen produced from the display data 71 is determined in the determination to fit in the range of the screen being produced by the application program in the current shape of the display area section 9, the section 84 outputs the display data 71 to the execution section 33 and instructs the section 33 to execute the application program using the display data 71.

On the other hand, if the screen produced from the display data 71 is determined in the determination not to fit in the range of the screen produced by the application program in the current shape of the display area section 9, the section 84 outputs the display data 71 to the execution section 33 and instructs the section 33 to temporarily suspend the execution of the application program using the display data 71. The data displayability determining section 84 further instructs the display driver 13 to produce a display instructing to alter the position of the display section 3. In other words, the data displayability determining section 84 instructs the display driver 13 to produce a display instructing to alter the range of the vertical and horizontal axes of the screen set up on the display area section 9.

Next will be described the flow of the display-data display properness determining processes 1 and 2 carried out on the mobile device 1 configured as above, in reference to

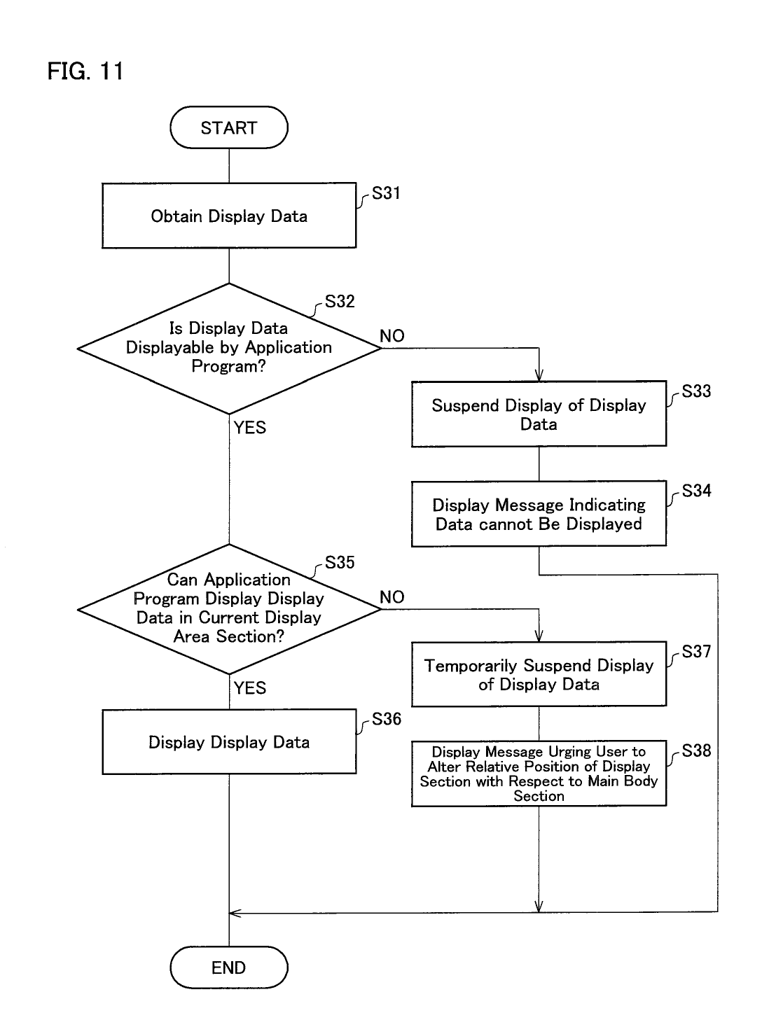

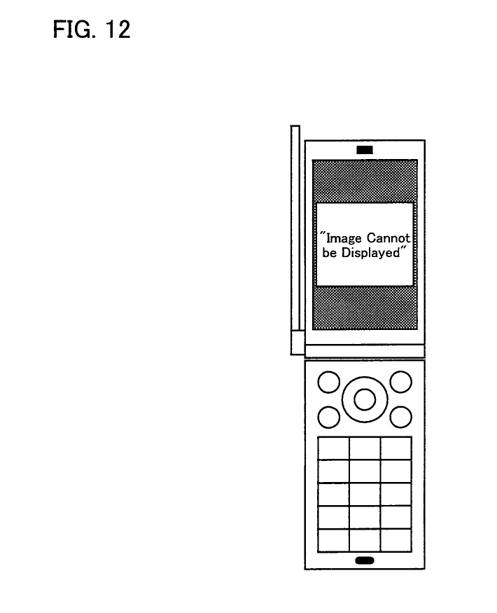

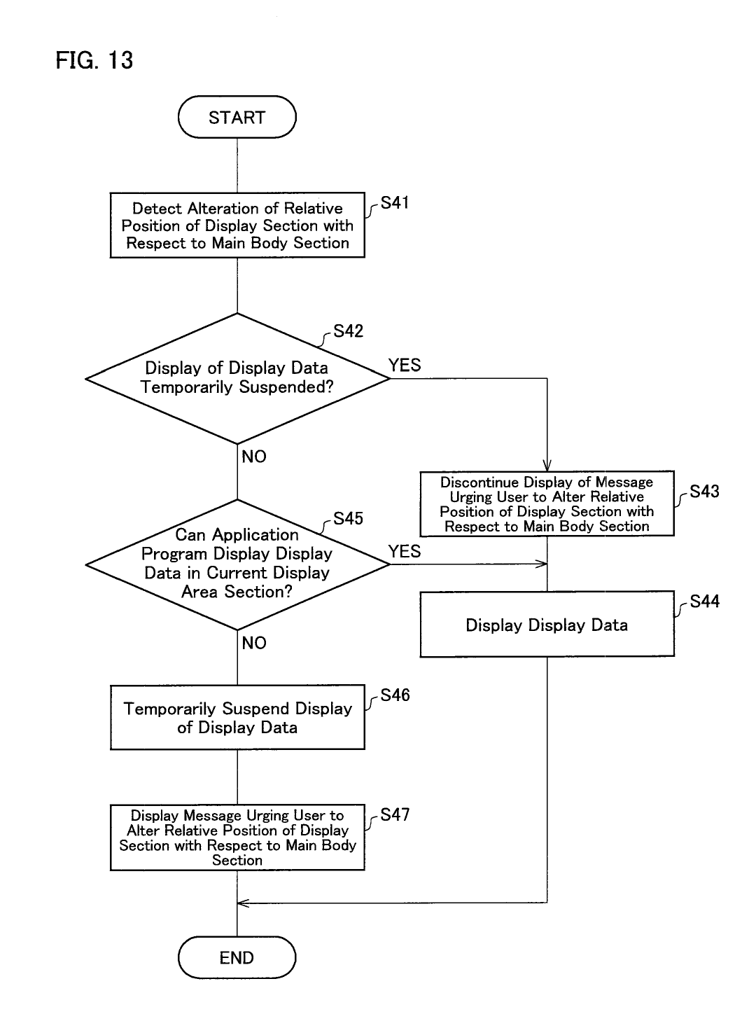

FIGS. 11 to 13. FIG. 11 is a flow chart depicting the display-data display properness determining process 1 carried out on the mobile device 1 in accordance with the present invention. FIG. 12 is a drawing showing an exemplary display produced on the mobile device 1 in accordance with the present invention based on prompt data. FIG. 13 is a flow chart depicting the display-data display properness determining process 2 carried out on the mobile device 1 in accordance with the present invention.

### Flow of Display-Data Display Properness Determining Process 1

First, assume that the screen produced by the execution of the application program on the mobile device 1 is adapted to display properly even if the relative positions of the display section 3 and the main body section 2 are altered.

Under the assumption, as the operation section 6 receives a user command to select the display data 71, the section 6 notifies the display data obtaining section 81 of the command. The display data obtaining section 81 retrieves and obtains the display data 71 from the data memory section 70 in response to the command received from the operation section 6 (S31). Then, the display data obtaining section 81 outputs the obtained display data 71 to the display range extracting section 82.

The display range extracting section 82 analyzes the display data 71, extracts display-data display range information, and outputs the display-data display range information together with the display data 71 to the data usability determining section 83. Upon receiving the display-data display range information, the data usability determining section 83 retrieves display range information 61 from the display range information memory section 60 and determines whether the screen produced from the display data 71 has such dimensions that the screen can be displayed by the application program executed (S32). In other words, the section 83 determines whether the display range of the screen produced from the display data 71 fits in the display range of the screen produced by the execution the application program.

In other words, if the dimensions (vertical and horizontal dimensions) of the screen produced from the display data 71 do not exceed, for example, (ah, aw) shown in FIG. 10(a) or (bh, bw) shown in FIG. 10(b), the screen produced from the display data 71 is determined to have such dimensions that the screen can be displayed by the application program.

If the screen produced from the display data 71 has such dimensions that the screen cannot be displayed by the application program (“NO” in S32), the data usability determining section 83 determines to suspend the execution of the display process based on the display data 71 (S33). The data usability determining section 83 then instructs the display driver 13 to display information indicating that the display data 71 selected cannot be displayed. The display driver 13 retrieves from the prompt data memory section 50 the prompt data 51 indicating that the display data 71 selected cannot be displayed and displays the data 51 on the display area section 9 (S34). The display is, for example, the text in FIG. 12 indicating that the display data 71 cannot be displayed on the display area section 9.

On the other hand, if the dimensions of the screen produced from the display data 71 are determined to fit in the range of the screen produced by the application program executed (“YES” in S32), the data usability determining section 83 instructs the data displayability determining section 84 as follows.

The data usability determining section 83 instructs the data displayability determining section 84 to determine whether or not the display data 71 can be displayed properly in the current shape of the display area section 9 with which the application program is being executed. When sending that instruction, the section 83 also transmits the display data 71 to the data displayability determining section 84.

The following points (1) to (3) should be further considered even if the dimensions of the screen produced from the display data 71 are determined to fit in the range of the screen produced by the application program executed.

(1) A screen can be displayed based on the display data 71 only when the screen displayed by the application program is being displayed in a portrait display area section 9.

(2) A screen can be displayed based on the display data 71 only when the screen displayed by the application program is being displayed in a landscape display area section 9.

(3) A screen can be displayed based on the display data 71 both when the screen displayed by the application program is being displayed in a portrait display area section 9 and when it is being displayed in a landscape portrait display area section 9.

Therefore, it is necessary to further determine whether the display data 71 can be displayed for each current shape of the display area section 9 with which the application program is being executed.

Accordingly, the data displayability determining section 84 instructs the obtaining section 31 to confirm whether the current shape of the display area section 9 is portrait or landscape and to determine whether or not the application program can display the display data 71 in the shape of the display area section 9 (S35).

More specifically, in response to an instruction from the data usability determining section 83, the data displayability determining section 84 requests the obtaining section 31 to obtain information on the current position of the display section 3 with respect to the main body section 2, that is, the shape of the display area section 9. The obtaining section 31, in response to the request from the displayability determining section 84, instructs the display orientation determining section 20 to obtain the current display position information regarding the display section 3. The display orientation determining section 20 responds to the instruction by obtaining the display position information from the detector section 10 and determining the current shape of the display area section 9, that is, the relative position of the display section 3 with respect to the main body section 2. The section 20 then outputs results of the determination to the obtaining section 31. As obtaining the results of the determination from the display orientation determining section 20, the obtaining section 31 outputs the results of the determination to the data displayability determining section 84. Accordingly, the data displayability determining section 84 learns the position of the display section 3 with respect to the current main body section 2, that is, the shape of the display area section 9, in the mobile device 1. In other words, the data displayability determining section 84 learns the vertical and horizontal axes of the screen set up on the display area section 9.

The data displayability determining section 84 further compares the range of the screen produced from the display data 71 received from the data usability determining section 83 with the range of the screen produced according to the shape of the display area section 9 learnt above based on the application program, by referring to the display range information 61.

As an example, suppose here that the dimensions of the vertical and horizontal axes on the screen produced from the display data 71 are dh and dw respectively in the range of the screen. Suppose also that the vertical and horizontal dimensions on the screen produced by the execution of the application program are ah and aw respectively in the range of the screen. If dh≦ah, and dw≦aw, the screen produced from the display data 71 is determined to be displayable on the screen produced by the execution of the application.

If the data displayability determining section 84 determines that the screen produced from the display data 71 is displayable (“YES” in S35), the section 84 outputs the display data 71 to the execution section 33 and instructs the section 33 to process the data 71. According to the instruction, the execution section 33 runs the application program and displays the screen from the display data 71 (S36). The section 33 then instructs the display driver 13 to produce a display which is a result of the execution of the application program on the display area section 9.

On the other hand, the data displayability determining section 84 determines that the screen produced from the display data 71 is not displayable (“NO” in S35), the section 84 outputs the display data 71 to the execution section 33 and instructs the section 33 to temporarily suspend displaying the screen from the display data 71 by the execution of the application program (S37). The execution section 33, according to the instruction from the data displayability determining section 84, temporarily suspends the display produced from the received display data 71. Furthermore, the data displayability determining section 84 instructs the display driver 13 to display, on the display area section 9, a message prompting the user to alter the relative position of the display section 3 with respect to the main body section 2 (S38).

The mobile device 1 in accordance with the present embodiment executes the display-data display properness determining process 1 as described in the foregoing.

Next will be described the flow of the “display-data display properness determining process 2” carried out when the relative position of the display section 3 with respect to the main body section 2 is altered while the application program using the display data 71 is being executed.

### Flow of Display-Data Display Properness Determining Process 2

An alteration of the relative position of the display section 3 with respect to the main body section 2 is detected while the application program producing the display of the display data 71 is being executed (S41). In other words, the display orientation determining section 20 receives the rotation information from the detector section 10. The display orientation determining section 20 then determines the post-alteration relative position of the display section 3 with respect to the main body section 2, that is, the shape of the display area section 9, and outputs results of the determination to the obtaining section 31.

The obtaining section 31, upon receiving the results of the determination, has the execution confirmation section 85 confirm the display state of the screen produced from the display data 71 by the currently running application program. The execution confirmation section 85, in response to the instruction from the obtaining section 31, asks the execution section 33 whether or not the screen produced from the display data 71 is being displayed. The execution confirmation section 85 then determines whether or not the display of the screen produced from the display data 71 is being temporarily suspended (S42).

The alteration of the position of the display section 3 is made either in response to the message displayed in step S38 in the “flow of the display-data display properness determining process 1” or regardless of the message. It is determined in step S42 in which one of the two cases the alteration falls.

A “YES” in step S42 corresponds to the case where the display section 3 was moved in response to the message displayed in step S38 in the “flow of the display-data display properness determining process 1.” Therefore, the “YES” in step S42 indicates that such a movement of the display section 3 was detected that the screen produced from the display data 71 can be displayed on the screen produced by the execution of the application program.

Accordingly, if the answer is “YES” in step S42, the execution confirmation section 85 instructs the display driver 13 to discontinue the display of the message (prompt data 51) prompting the user to alter the relative position of the display section 3 with respect to the main body section 2. In response to the instruction, the display driver 13 discontinues the display of the message (S43).

The execution confirmation section 85 then instructs the execution section 33 to resume the temporarily suspended display of the display data. Upon receiving the instruction from the execution confirmation section 85, the execution section 33 executes the application program to display a screen from the display data 71 (S44).

If the answer is “NO” in step S42, that part of the process which follows (steps S45 to S47 and S44) is the same as steps S35 to S38 in the aforementioned “flow of the display-data display properness determining process 2.” Detailed description of that part is omitted.

In step S45, the data displayability determining section 84 determines, based on the results of the determination made by the display orientation determining section 20 on the rotation information and fed from the execution confirmation section 85 and based also on the display range information 61, whether the screen produced from the display data 71 can be displayed on the screen produced by the execution of the application program on the current display area section 9 (S45). In other words, the section 84 determines whether or not the display data 71 can be displayed by the execution of the application program on the current display area section 9.

If the screen produced from the display data 71 is determined to be displayable on the screen produced by the execution of the application program (“YES” in step S45), the data displayability determining section 84 instructs the execution section 33 to execute the application program to continue the display of the display data 71 (S44).

On the other hand, if the answer is “NO” in step S45, the data displayability determining section 84 instructs the execution section 33 to temporarily suspend the execution of the application program (S46). Furthermore, the section 84 instructs the display driver 13 to display a message on the display area section 9 prompting the user to alter the relative position of the display section 3 with respect to the main body section 2 (S47).

The mobile device 1 executes the “display-data display properness determining process 2” as described in the foregoing when the relative position of the display section 3 with respect to the main body section 2 is altered.

As described in the foregoing, the mobile device 1 in accordance with the present embodiment determines whether the display range of the screen produced from the display data 71 by the execution of the application program fits in the screen range of the application program on the current display area section 9 even when the application program is compatible with the shape of the display area section. If the display range of the display data 71 does not fit in the screen range of the application program on the current display area section 9, the device 1 can instruct to move the display section 3 so as to alter the shape of the display area section 9. In other words, the device 1 is capable of instructing to alter the vertical and horizontal axes of the screen produced by the execution of the application program set up on the display area section 9.

The mobile device 1 in accordance with the present embodiment, as detailed in the foregoing, is capable of prompting the user to move the display section 3, that is, to alter the vertical and horizontal axis setup for the screen displayed on the display area section 9. Therefore, the device 1 is capable of properly displaying the screen produced from the display data 71 by altering the current vertical and horizontal axis setup for the screen on the display area section 9 even if the screen produced from the display data 71 cannot be displayed in the range of the screen produced by the execution of the application program with the vertical and horizontal axis setup.

Therefore, even when the display data 71 is retrieved when the application program is executed, the display layout is appropriate. Therefore, when the copyright holder does not want the design, layout, etc. of the screen displayed by the execution of the application program from the display data 71 to be degraded and hence disapproves scaling up/down and similar manipulation, the device 1 prompts the user to move the display section 3 so that the screen produced from the display data 71 can be displayed properly.

Furthermore, the mobile device 1 in accordance with the present embodiment does not require that the application program producing the screen from the display data 71 be designed in advance so as to display a screen from the display data 71 which is compatible with display areas with different aspect ratios. Therefore, the cost of application program development is reduced.

The display data 71 obtained may be image data or provided in the form of a computer program executable on particular application programs, such as a Java® applet or a Flash animation. The mobile device 1 in accordance with the present embodiment is capable of executing the “display-data display properness determining processes 1 and 2” in the same manner even if the display data 71 is provided in the form of a computer program executable on particular application programs.

The “display-data display properness determining processes 1 and 2” have so far been assumed that it is not allowed to subject the display data 71 to scaling up/down (resizing) or trimming. However, if the provider of the display data 71 does not place any particular restrictions on the image scaling up/down (resizing) and trimming of the display data 71, the display range extracting section 82 may behave as follows.

If the display data 71 has no restrictive settings for resizing, the display range extracting section 82, upon receiving the display data 71 from the display data obtaining section 81, calculates information on the lowest scale-down rate at which the display data 71 can be displayed on the display area section 9. The section 82 outputs results of the calculation as display-data display range information to the data usability determining section 83.

If the display data 71 has no restrictive settings for trimming, the section 82 outputs to the data usability determining section 83 a display range (0,0), that is, values indicating a minimum display area range on the display area section 9, as the display-data display range information.

The data usability determining section 83 then determines, from the display-data display range information extracted by the display range extracting section 82 and the display range information 61 obtained from the display range information memory section 60, whether the screen produced from the display data 71 fits in the range of the screen produced by the execution of the application program.

In practice, the display-data display range information indicates a narrower range than the display range information 61. The data usability determining section 83 therefore determines that the display data 71 can be displayed in the range of the screen displayed by the execution of the application program.

When the data usability determining section 83 determines in this manner that the screen produced from the display data 71 fits in the range of the display screen of the application program, the section 83 outputs the display-data display range information together with the display data 71 to the data displayability determining section 84.

The data displayability determining section 84 determines whether the screen produced from the display data 71 can be displayed properly on the screen produced by the execution of the application program in the range specified by means of the vertical and horizontal axes of the screen set up on the current display area section 9.

Since the display range information is the values indicating the lowest scale-down rate at which the display data 71 can be displayed or the minimum display area range on the display area section 9, the data displayability determining section 84 determines that the screen produced from the display data 71 fits in the range specified by means of the vertical and horizontal axes of the screen set up on the display area section 9.

The execution section 33 then executes a display process on the display data 71. In the display process, the execution section 33 resizes or trims the screen produced from the display data 71 properly to a range which fits in the screen displayed by the execution of the application program so that the screen can be displayed properly.

The mobile device 1 in accordance with the present embodiment displays from the display data 71 properly in this manner even when the display data 71 has no restrictions for scaling up/down (resizing) or trimming.

The mobile device 1 in accordance with the present embodiment has been described as being so configured that the relative positions of the main body section 2 and the display section 3 are alterable by the rotation mechanism provided in the hinge section 4, thereby enabling switching of the shape of the display area section 9 between portrait and landscape. However, the alterations of the shape of the display area section 9 are by no means limited to physical alterations.

For example, the display layout may be altered to be compatible with a portrait display area section 9 or a landscape display area section 9 in response to a command input on the operation section 6. Any other alterations may be made in accordance with switching by the installed system program.

If the vertical and horizontal axes for a display layout are altered by the installed system program on the display area section 9 in this manner, the mobile device 1 may receive an alteration command through the operation section 6. In this configuration, the operation section 6 corresponds to the detector section of the present invention.

The application program installed in the mobile device 1 in accordance with the present embodiment has been described as being pre-installed in the mobile device 1. The application may be downloaded from an external device.

The mobile device 1 in accordance with the present embodiment is capable of executing a combination of the “execution properness determining process for the application program” and the “display-data display properness determining process.” The device 1 does so by executing the “execution properness determining process for the application program” to confirm whether the application program is compatible with the current shape of the display area section 9 and thereafter executing the “display-data display properness determining process.”

As described in the foregoing, the display device in accordance with the present invention may be described as including the following configurations. In addition, the method of controlling a display device in accordance with the present invention may be described as involving the following steps.

A display device in accordance with the present invention, as described in the foregoing, is a display device capable of altering relationship between a vertical axis and a horizontal axis by means of which to specify a position in a display area in which a first screen produced by execution of an installed program is displayed, wherein the first screen should be displayed at that position, the device including: displayability determining means for comparing a display area range indicating a range of the display area and a first screen range indicating a display range of the first screen specified by means of the relationship between the vertical axis and the horizontal axis of the first screen, to determine whether or not the first screen range fits in the display area range; and output means for, upon the displayability determining means determining that the first screen range does not fit in the display area range, outputting a result of the determination.

The display device in accordance with the present invention thus has advantages that development cost is lowered and that the screen is properly displayed by prompting the user to alter the vertical and horizontal axis setup corresponding to the display area.

A method of controlling a display device in accordance with the present invention, as described in the foregoing, is a method of controlling a display device capable of altering relationship between a vertical axis and a horizontal axis by means of which to specify a position in a display area in which a first screen produced by execution of an installed program is displayed, wherein the first screen should be displayed at that position, the method including the steps of: the first step of comparing a display area range indicating a range of the display area and a first screen range indicating a display range of the first screen specified by means of the vertical axis and the horizontal axis of the first screen, to determine whether or not the first screen range fits in the display area range; and the second step of, if the display range of the first screen is determined in the first step not to fit in the display area range, outputting a result of the determination.

The method of controlling a display device in accordance with the present invention thus has advantages that development cost is lowered and that the screen is properly displayed by prompting the user to alter the vertical and horizontal axis setup corresponding to the display area.

The display device in accordance with the present invention, in the above structure, is preferably structured so that it further includes display layout determining means for determining the position, at which the first screen should be displayed, specified by means of the relationship between the vertical axis and the horizontal axis of the first screen in the display area, wherein the displayability determining means determines, based on a result of the determination made by the display layout determining means, the first screen range which is the display range of the first screen which should be displayed at the position specified by means of the relationship between the vertical axis and the horizontal axis in the display area, to determine whether or not the first screen range fits in the display area range.

According to the structure, the device includes the display layout determining means and can hence determine the layout of the first screen specified by means of the vertical axis and the horizontal axis in the display area. Therefore, the displayability determining means can determine the first screen range which is the display range of the first screen whose layout is specified by means of the vertical axis and the horizontal axis in the display area, to determine whether or not the first screen range fits in the display area range.

Therefore, the display device in accordance with the present invention can confirm whether the first screen whose layout is specified by means of the relationship between the vertical axis and the horizontal axis can be properly displayed in the display area.

The display device in accordance with the present invention, in the above structure, is preferably structured so that it further includes display processing means for performing a display process for the first screen, wherein the displayability determining means, upon determining that the first screen range does not fit in the display area range, instructs the display processing means to suspend the display process for the first screen.

According to the structure, when the first screen range is determined not to fit in the display area range, the displayability determining means instructs the display processing means to suspend the display process for the first screen, thereby preventing the first screen from being improperly displayed.

The display device in accordance with the present invention, in the above structure, is preferably structured so that it further includes: a detector section for detecting an alteration of the relationship between the vertical axis and the horizontal axis of the first screen in the display area; and first confirmation means for, upon the detector section detecting an alteration of the relationship between the vertical axis and the horizontal axis, confirming a current state of the display process being performed by the display processing means for the first screen.

According to the structure, the device further includes the detector section and the first confirmation means and can hence learn the state of the display process for the first screen when the relationship between the vertical axis and the horizontal axis by means of which to specify the position at which the first screen should be displayed is altered. Also, when the relationship between the vertical axis and the horizontal axis is altered, the device confirms according to the state of the display process for the first screen whether to suspend or continue the display process for the first screen.

The display device in accordance with the present invention, in the above structure, is preferably structured so that upon confirming as the state of the display process for the first screen that the display process for the first screen is being suspended, the first confirmation means instructs the display processing means to resume the display process and instructs the output means to stop outputting a result of the determination made by the displayability determining means.

That the display process for the first screen is confirmed as being suspended as the current state of the display process for the first screen means that the alteration of the relationship between the vertical axis and the horizontal axis is made based on the result of the determination output by the output means. Therefore, the alteration of the relationship between the vertical axis and the horizontal axis is an alteration that makes the first screen properly displayed.

Therefore, when the relationship between the vertical axis and the horizontal axis by means of which to specify the position at which the first screen should be displayed in the display area is altered, the display device in accordance with the present invention stops the output means from outputting information based on the result of the determination and resumes the display process for the first screen being suspended, so that the first screen can be properly displayed.

The display device in accordance with the present invention, in the above structure, is preferably structured so that upon confirming as the state of the display process for the first screen that the display process for the first screen is being performed, the first confirmation means instructs the display processing means to suspend the display process and instructs the displayability determining means to determine whether or not the first screen range fits in the display area range after the relationship between the vertical axis and the horizontal axis is altered.

That the display process for the first screen is confirmed as being performed as the current state of the display process for the first screen means that the alteration of the relationship between the vertical axis and the horizontal axis is not made based on the result of the determination output by the output means.

Therefore, when the relationship between the vertical axis and the horizontal axis by means of which to specify the position at which the first screen should be displayed in the display area is altered, the display device in accordance with the present invention suspends the display of the first screen and determines whether the first screen can be properly displayed after the alteration. Therefore, the display device can confirm whether the first screen can be displayed properly in the display area after the relationship between the vertical axis and the horizontal axis of the first screen is altered.

The display device in accordance with the present invention, in the above structure, is preferably structured so that the program installed to produce the first screen is an application program designed to retrieve image data and display on the first screen a second screen in which an image is reproduced from the image data, the device further including: image data determining means for determining whether or not the second screen can be displayed from the image data in the display range of the first screen; and screen display determining means for, upon the image data determining means determining that the second screen can be displayed from the image data in the first screen range, determining whether or not the second screen fits in the first screen range specified by means of the vertical axis and the horizontal axis, wherein upon the screen display determining means determining that the second screen does not fit in the first screen range specified by means of the relationship between the vertical axis and the horizontal axis, the output means outputs a result of the determination made by the screen display determining means.

According to the structure, the device includes the image data determining means and therefore can confirm whether the second screen can be displayed in the first screen range. The device further includes the screen display determining means and therefore can confirm whether the second screen that can be displayed in the first screen range fits in the first screen range whose layout in the display area is specified by means of the relationship between the vertical axis and the horizontal axis.

In addition, the device includes the output means and therefore if the screen display determining means determines that the second screen does not fit in the first screen range, can output a result of the determination made by the screen display determining means.

Hence, the display device in accordance with the present invention can notify that the second screen cannot be displayed in the first screen being displayed in the display area. From the notification, the user can know, for example, the need for an alteration of the relationship between the vertical axis and the horizontal axis by means of which to specify the position at which the first screen should be displayed in the display area.

Therefore, even if the second screen cannot be displayed in the first screen range, the display device in accordance with the present invention can properly display the second screen by altering the relationship between the vertical axis and the horizontal axis. Therefore, the device functions properly even if the provider of the image data does not allow scaling up/down (resizing) and trimming of the second screen produced from the image data.

Furthermore, no program for displaying the second screen that is compatible with the relationship between the vertical axis and the horizontal axis by means of which to specify the position at which the first screen should be displayed in the display area needs to be designed in advance, which lowers development cost.

The display device in accordance with the present invention therefore lowers development cost and properly display the second screen by prompting the user to alter the relationship between the vertical axis and the horizontal axis of the first screen so as to be compatible with the display range of the second screen.

The display device in accordance with the present invention, in the above structure, is preferably structured so that it further includes: a memory device for storing first screen display range information indicating the display range of the first screen specified by means of the relationship between the vertical axis and the horizontal axis; and extraction means for extracting, from the image data, information on a display range of the second screen based on the image data, wherein the image data determining means compares the first screen display range information stored in the memory device and the information on the display range of the second screen extracted by the extraction means, to determine whether or not the second screen can be displayed from the image data in the display range of the first screen.

According to the structure, the device includes the memory device and the extraction means and therefore can obtain the first screen display range information and the information on the display range of the second screen. Thus, the image data determining means can determine whether or not the second screen can be displayed from the image data in the display range of the first screen by using the information obtained.

The display device in accordance with the present invention, in the above structure, is preferably structured so that the screen display determining means determines whether or not the second screen fits in the first screen range specified by means of the relationship between the vertical axis and the horizontal axis, from the first screen display range information stored in the memory device, the information on the display range of the second screen extracted by the second screen extraction means extracted by the extraction means, and the result of the determination made by the display layout determining means as to the position at which the first screen specified by means of the relationship between the vertical axis and the horizontal axis should be displayed.

According to the structure, the screen display determining means obtains the first screen display range information, the information on the second display range of the screen, and the result of the determination as to the position at which the first screen specified by means of the relationship between the vertical axis and the horizontal axis should be displayed. Therefore, by using the information, the screen display determining means determines whether or not the second screen fits in the display range of the first screen which should be displayed at the position specified by means of the relationship between the vertical axis and the horizontal axis in the display area.

The display device in accordance with the present invention, in the above structure, is preferably structured so that the display processing means is performing a display process for the second screen in the first screen as a display process on the first screen; and upon determining that the second screen does not fit in the display range of the first screen, the image data determining means instructs the display processing means to suspend the display process for the second screen in the first screen and instructs the output means to output information indicating that the second screen cannot be displayed.

According to the structure, upon determining that the second screen does not fit in the display range of the first screen, the image data determining means instructs the display processing means to suspend the display process for the second screen in the first screen, thereby preventing the second screen from being improperly displayed on the first screen.

In addition, the output means outputs information indicating that the second screen cannot be displayed in the first screen, thereby notifying the user of the display device that the second screen is image data that cannot be displayed on the first screen.

The display device in accordance with the present invention, in the above structure, preferably further includes second confirmation means for, upon the detector section detecting an alteration of the relationship between the vertical axis and the horizontal axis, confirming a current state of the display process for the second screen in the first screen.

According to the structure, the device further includes the second confirmation means. The device therefore can learn the state of the display process for the second screen in the first screen when the vertical and horizontal axis setup for the first screen is altered. Also, when the relationship between the vertical axis and the horizontal axis is altered, the device confirms according to the state of the display process for the second screen in the first screen whether to suspend or continue the display process for the second screen.

The display device in accordance with the present invention, in the above structure, is preferably structured so that upon confirming as the current state of the display process for the second screen in the first screen that the display process for the second screen in the first screen is being suspended, the second confirmation means instructs the display processing means to resume the display process and instructs the output means to stop outputting the result of the determination made by the screen display determining means.

That the display process for the second screen in the first screen is confirmed as being suspended as the current state of the display process for the second screen in the first screen means that the alteration of the relationship between the vertical axis and the horizontal axis in the first screen is made based on the result of the determination made by the screen display determining means and output by the output means. Therefore, the alteration of the vertical and horizontal axis setup is an alteration that makes the second screen properly displayed in the first screen.

Therefore, when the vertical and horizontal axis setup for the first screen in the current display area is altered so that the second screen can be properly displayed in the first screen, the display device in accordance with the present invention makes the screen display determining means stop outputting the result of the determination and makes the suspended display process for the second screen in the first screen resumed.

The display device in accordance with the present invention, in the above structure, is preferably structured so that upon confirming as the current state of the display process for the second screen in the first screen that the display process for the second screen in the first screen is being performed, the second confirmation means instructs the display processing means to suspend the display process and instructs the screen display determining means to determine whether or not the second screen fits in the first screen range which should be displayed at the position specified by means of the relationship between the vertical axis and the horizontal axis in the display area.

That the display process for the second screen in the first screen is confirmed as being performed as the state of the display process for the second screen in the first screen means that the alteration of the relationship between the vertical axis and the horizontal axis is not made based on the result of the determination output by the output means.

Therefore, when the relationship between the vertical axis and the horizontal axis of the first screen in the display area is altered, the display device in accordance with the present invention suspends the display of the second screen in the first screen and determines whether the second screen can be properly displayed in the first screen range after the alteration. Therefore, the display device can confirm whether the second screen can be displayed properly in the first screen after the relationship between the vertical axis and the horizontal axis of the first screen is altered.

The display device in accordance with the present invention, in the above structure, is preferably structured so that upon the displayability determining means determining that the display range of the first screen does not fit in the display area range, the output means outputs, as a result of the determination, information prompting a user to alter the relationship between the vertical axis and the horizontal axis of the first screen.

According to the structure, the device can prompt the user to alter the relationship between the vertical axis and the horizontal axis. Even when the first screen which should be displayed at the position specified by means of the current vertical and horizontal axes cannot be displayed in the display area, the device can display the first screen properly in the display area by altering the relationship between the vertical axis and the horizontal axis.

The display device in accordance with the present invention, in the above structure, is preferably structured so that upon the screen display determining means determining that the second screen does not fit in the first screen range specified by means of the relationship between the vertical axis and the horizontal axis, the output means outputs, as a result of the determination, information prompting a user to alter the relationship between the vertical axis and the horizontal axis of the first screen.

According to the structure, the device can prompt the user to alter the relationship between the vertical axis and the horizontal axis. Even when the second screen cannot be displayed in the first screen which should be displayed at the position specified by means of the current vertical and horizontal axes, the device can display the second screen properly in the first screen range by altering the relationship between the vertical axis and the horizontal axis.

The display device may be computer-implemented. When that is the case, the present invention encompasses a program for controlling a display device causing a computer to operate as the various means to realize the display device on the computer and a computer-readable storage medium containing the program.

The present invention is not limited to the description of the embodiments above, but may be altered by a skilled person within the scope of the claims. An embodiment based on a proper combination of technical means disclosed in different embodiments is encompassed in the technical scope of the present invention.

The foregoing description has described the hardware as the mobile device 1 including various sections and components and the software as a system program providing common functions across application programs and an application program realizing application-specific functions.

This is however by no means limiting the program installed in the mobile device 1. The system program and the application program may be designed as a single program.

The blocks of the mobile device 1, especially, the display orientation determining section 20, the functional blocks in the application processing section 30, and the display driver 13, may be implemented by software executed by a CPU as follows:

The mobile device 1 includes a CPU (central processing unit) and memory devices (storage media). The CPU executes instructions contained in control programs, realizing various functions. The memory devices may be a ROM (read-only memory) containing programs, a RAM (random access memory) to which the programs are loaded, or a memory containing the programs and various data. The objectives of the present invention can be achieved also by mounting to the mobile device 1 a computer-readable storage medium containing control program code (executable programs, intermediate code programs, or source programs) of the system program and application program for the mobile device 1 which are software realizing the aforementioned functions, in order for a computer (or CPU, MPU) to retrieve and execute the program code contained in the storage medium.

The storage medium may be, for example, a tape, such as a magnetic tape or a cassette tape; a magnetic disk, such as a floppy® disk or a hard disk, or an optical disc, such as CD-ROM/MO/MD/DVD/CD-R; a card, such as an IC card (memory card) or an optical card; or a semiconductor memory, such as a mask ROM/EPROM/EEPROM/flash ROM.

The mobile device 1 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, an electric power line, a cable TV line, a telephone line, or an ADSL; or wireless, such as infrared (IrDA, remote control), Bluetooth®, 802.11 wireless, HDR, a mobile telephone network, a satellite line, or a terrestrial digital network. The present invention encompasses a carrier wave, or data signal transmission, in which the program code is embodied electronically.

### INDUSTRIAL APPLICABILITY

The mobile device 1 allows for such alternation of the vertical and horizontal axis setup for the screen displayed by the execution of the application program in the display area section 9 that the screen can be displayed properly in the display area section 9. The device 1 thus allows for such alteration of the vertical and horizontal axis setup for the screen that the display range of the screen displayed in the display area section 9 falls in the range of the display area section 9.

1.-18. (canceled)

19. A display device capable of altering relationship between a vertical axis and a horizontal axis by means of which to specify a position in a display area in which a first screen produced by execution of an installed program is displayed, wherein the first screen should be displayed at that position, said device comprising:
displayability determining means for comparing a display area range indicating a range of the display area and a first screen range indicating a display range of the first screen specified by means of the relationship between the vertical axis and the horizontal axis, to determine whether or not the first screen range fits in the display area range;
output means for, upon the displayability determining means determining that the first screen range does not fit in the display area range, outputting a result of the determination;
display layout determining means for determining the position, at which the first screen should be displayed, specified by means of the relationship between the vertical axis and the horizontal axis of the first screen in the display area; and
display processing means for performing a display process for the first screen, wherein:
the displayability determining means determines, based on a result of the determination made by the display layout determining means, the first screen range which is the display range of the first screen which should be displayed at the position specified by means of the relationship between the vertical axis and the horizontal axis in the display area, to determine whether or not the first screen range fits in the display area range;
the displayability determining means, upon determining that the first screen range does not fit in the display area range, instructs the display processing means to suspend the display process for the first screen, said device further comprising:
a detector section for detecting an alteration of the relationship between the vertical axis and the horizontal axis of the first screen in the display area; and
first confirmation means for, upon the detector section detecting an alteration of the relationship between the vertical axis and the horizontal axis, confirming a state of the display process for the first screen at a time of the detection of the alteration of the relationship between the vertical axis and the horizontal axis.

20. The display device as set forth in claim 19, wherein upon confirming as the state of the display process for the first screen that the display process for the first screen is being suspended, the first confirmation means instructs the display processing means to resume the display process and instructs the output means to stop outputting a result of the determination made by the displayability determining means.

21. The display device as set forth in claim 19, wherein upon confirming as the state of the display process for the first screen that the display process for the first screen is being performed, the first confirmation means instructs the display processing means to suspend the display process and instructs the displayability determining means to determine whether or not the first screen range fits in the display area range after the relationship between the vertical axis and the horizontal axis is altered.

22. The display device as set forth in claim 19, wherein the program installed to produce the first screen is an application program designed to retrieve image data and display on the first screen a second screen in which an image is reproduced from the image data, said device further comprising:
image data determining means for determining whether or not the second screen can be displayed from the image data in the display range of the first screen; and
screen display determining means for, upon the image data determining means determining that the second screen can be displayed from the image data in the first screen range, determining whether or not the second screen fits in the first screen range specified by means of the vertical axis and the horizontal axis, wherein
upon the screen display determining means determining that the second screen does not fit in the first screen range specified by means of the relationship between the vertical axis and the horizontal axis, the output means outputs a result of the determination made by the screen display determining means.

23. The display device as set forth in claim 22, further comprising:
a memory device for storing first screen display range information indicating the display range of the first screen specified by means of the relationship between the vertical axis and the horizontal axis; and
extraction means for extracting, from the image data, information on a display range of the second screen based on the image data, wherein
the image data determining means compares the first screen display range information stored in the memory device and the information on the display range of the second screen extracted by the extraction means, to determine whether or not the second screen can be displayed from the image data in the display range of the first screen.

24. The display device as set forth in claim 23, wherein the screen display determining means determines whether or not the second screen fits in the first screen range specified by means of the relationship between the vertical axis and the horizontal axis, from the first screen display range information stored in the memory device, the information on the display range of the second screen extracted by the extraction means, and the result of the determination made by the display layout determining means as to the position at which the first screen specified by means of the relationship between the vertical axis and the horizontal axis should be displayed.

25. The display device as set forth in claim 24, wherein:
the display processing means is performing a display process for the second screen in the first screen as a display process on the first screen; and
upon determining that the second screen does not fit in the display range of the first screen, the image data determining means instructs the display processing means to suspend the display process for the second screen in the first screen and instructs the output means to output information indicating that the second screen cannot be displayed.

26. The display device as set forth in claim 25, further comprising second confirmation means for, upon the detector section detecting an alteration of the relationship between the vertical axis and the horizontal axis, confirming a current state of the display process for the second screen in the first screen.

27. The display device as set forth in claim 26, wherein upon confirming as the current state of the display process for the second screen in the first screen that the display process for the second screen in the first screen is being suspended, the second confirmation means instructs the display processing means to resume the display process and instructs the output means to stop outputting the result of the determination made by the screen display determining means.

28. The display device as set forth in claim 26, wherein upon confirming as the current state of the display process for the second screen in the first screen that the display process for the second screen in the first screen is being performed, the second confirmation means instructs the display processing means to suspend the display process and instructs the screen display determining means to determine whether or not the second screen fits in the first screen range which should be displayed at the position specified by means of the relationship between the vertical axis and the horizontal axis in the display area.

29. The display device as set forth in claim 19, wherein upon the displayability determining means determining that the display range of the first screen does not fit in the display area range, the output means outputs, as a result of the determination, information prompting a user to alter the relationship between the vertical axis and the horizontal axis of the first screen.

30. The display device as set forth in claim 22, wherein upon the screen display determining means determining that the second screen does not fit in the first screen range specified by means of the relationship between the vertical axis and the horizontal axis, the output means outputs, as a result of the determination, information prompting a user to alter the relationship between the vertical axis and the horizontal axis of the first screen.

31. A method of controlling a display device capable of altering relationship between a vertical axis and a horizontal axis by means of which to specify a position in a display area in which a first screen produced by execution of an installed program is displayed, wherein the first screen should be displayed at that position,
said method comprising the steps of:
the position determining step of determining the position, at which the first screen should be displayed, specified by means of the relationship between the vertical axis and the horizontal axis of the first screen in the display area;
the determining step of determining, based on a result of the determination in the position determining step, a first screen range which is a display range of the first screen which should be displayed at the position specified by means of the relationship between the vertical axis and the horizontal axis in the display area and comparing a display area range indicating a range of the display area and the first screen range determined, to determine whether or not the first screen range fits in the display area range;
the suspension instructing step of, upon determining in the determining step that the first screen range does not fit in the display area range, outputting a result of the determination and instructing to suspend a display process for the first screen;
the display processing step of, upon determining in the determining step that the display range of the first screen fits in the display area range, performing the display process for the first screen;
the detection step of detecting an alteration of the relationship between the vertical axis and the horizontal axis of the first screen in the display area; and
the confirmation step of, if an alteration of the relationship between the vertical axis and the horizontal axis is detected in the detection step, confirming a state of the display process for the first screen at a time of the detection of the alteration of the relationship between the vertical axis and the horizontal axis.

32. A computer-readable storage medium containing a program for controlling a display device, said device being capable of altering relationship between a vertical axis and a horizontal axis by means of which to specify a position in a display area in which a first screen produced by execution of an installed program is displayed, wherein the first screen should be displayed at that position, said device comprising:
displayability determining means for comparing a display area range indicating a range of the display area and a first screen range indicating a display range of the first screen specified by means of the relationship between the vertical axis and the horizontal axis of the first screen, to determine whether or not the first screen range fits in the display area range;
output means for, upon the displayability determining means determining that the first screen range does not fit in the display area range, outputting a result of the determination;
display layout determining means for determining the position, at which the first screen should be displayed, specified by means of the relationship between the vertical axis and the horizontal axis of the first screen in the display area; and
display processing means for performing a display process for the first screen, wherein:
the displayability determining means determines, based on a result of the determination made by the display layout determining means, the first screen range which is the display range of the first screen which should be displayed at the position specified by means of the relationship between the vertical axis and the horizontal axis in the display area, to determine whether or not the first screen range fits in the display area range;
the displayability determining means, upon determining that the first screen range does not fit in the display area range, instructs the display processing means to suspend the display process for the first screen, said device further comprising:
a detector section for detecting an alteration of the relationship between the vertical axis and the horizontal axis of the first screen in the display area; and
first confirmation means for, upon the detector section detecting an alteration of the relationship between the vertical axis and the horizontal axis, confirming a state of the display process for the first screen at a time of the detection of the alteration of the relationship between the vertical axis and the horizontal axis.
